(19) United States
(12) Patent Application Publication
(10) Pub. No.: US 2020/0012023 A1
(43) Pub. Date: Jan. 9, 2020

(54) Lens System for Use with High Laser Power Density Scanning System

(71) Applicant: Newport Corporation, Irvine, CA (US)

(72) Inventors: Richard Twedt, Wildomar, CA (US); Daniel Hedberg, Anaheim, CA (US); Edmund Arriola, Huntington Beach, CA (US)

(73) Assignee: Newport Corporation, Irvine, CA (US)

(21) Appl. No.: 16/492,919

(22) PCT Filed: Apr. 25, 2018
(86) PCT No.: PCT/US2018/029282

§ 371 Date: Sep. 10, 2019

Related U.S. Application Data
(60) Provisional application No. 62/490,409, filed on Apr. 26, 2017.

(51) Int. Cl. G02B 5/18; G02B 13/22

(52) U.S. Cl. CPC G02B 5/189; G02B 13/22

(57) ABSTRACT

A lens system for use with a high laser power density scanning system is disclosed and includes a first lens group having one or more refractive optical elements therein. The first lens group is in communication with at least one high average power laser scanning system and is configured to transmit at least one high average laser power density signal there through. At least a second lens group having one or more refractive optical elements therein is in communication with the laser scanning system via the first lens group. The second lens group is configured to transmit the high average laser power density signal there through. At least one diffractive optical element may be in communication with at least one of the first lens group and the second lens group and is configured to transmit the at least one high average laser power density signal there through.

### CROSS-REFERENCE TO RELATED APPLICATIONS

The present application claims priority to U.S. Provisional Patent Appl. Ser. No. 62/490,409, filed on Apr. 26, 2017, and entitled “Lens System for Use with High Laser Power Density Scanning System,” the entire contents of which are hereby incorporated by reference herein.

### BACKGROUND

High laser power density scanning systems are presently used in a number of applications. For example, high-power laser scanning systems are frequently used in semiconductor manufacturing applications, electronic device manufacturing processes, and similar applications. Typically, high-power laser scanning systems include at least one lens system configured to direct laser light to a workpiece and/or work surface. Prior art lens systems used in these scanning systems include multiple refractive optical elements configured to condition and direct optical energy to the workpiece and/or work surface.

While prior art lens systems offered a large field of view which enabled the formation of multiple features on a work surface simultaneously, a number of shortcomings have been identified. For example, prior art lens systems used in laser scanning systems are not well suited for use with optical signals having high laser power density. Further, these prior art lens systems were primarily designed for forming course features (i.e. features having transverse dimensions measured in millimeters) on the workpiece and/or work surface. As such, the formation of smaller and/or more precise features (i.e. features having transverse dimensions measured in microns) has proven to be particularly problematic. In addition, prior art systems utilize multiple lenses manufactured from different of optical materials. As a result, prior optical systems typically suffer from a higher absorption which results in a temperature variation between the optical components used in the lens system, thereby increasing system distortion. Also, prior art lens systems suffer typically from high lateral chromatic aberration, resulting in undesirable variations in spots size and/or shape and variations in the processing of the workpiece and/or work surface.

In light of the foregoing, there is an ongoing need for a lens system for use with a high laser power density scanning system.

### SUMMARY

The present application is directed to a lens system for use with a high laser power density scanning system. More specifically, the lens system may be used in conjunction with a high laser power density scanning system to form one or more features, voids, and/or holes in one or more workpieces or surfaces. In one embodiment, the present application discloses a lens system for use with a high laser power density scanning system and includes a first lens group having one or more refractive optical elements therein. The first lens group may be in optical communication with at least one high average power laser scanning system and may be configured to transmit at least one high average laser power density signal there through. At least a second lens group having one or more refractive optical elements therein may be in optical communication with the high average power laser scanning system via the first lens group. Like the first lens group, the second lens group may be configured to transmit the high average laser power density signal there through. In addition, at least one diffractive optical element may be in optical communication with at least one of the first lens group and the second lens group, wherein the at least one diffractive optical element may be configured to transmit the high average laser power density signal there through.

The present application further discloses another embodiment of a lens system for use with a high laser power density scanning system. The lens system may include a first lens group having one or more refractive optical elements therein. The first lens group is in optical communication with at least one high average power laser scanning system and may be configured to transmit at least one high average laser power density signal there through. The lens system may further include at least one diffractive optical element in optical communication with the first lens group and configured to receive the at least one high average laser power density signal from the first lens group and transmit the at least one high average laser power density signal there through. Lastly, the lens system may further include at least a second lens group having one or more refractive optical elements therein. The second lens group may be in optical communication with the high average power laser scanning system via the diffractive optical element. During use, the second lens group may be configured to transmit the high average laser power density signal there through.

Further, the present application further discloses a lens system configured to mitigate the effects of chromatic aberration and thermal lensing for use with a high laser power density scanning system. More specifically, the lens system may include a first lens group having one or more refractive optical elements therein. The first lens group may be in optical communication with at least one high average power laser scanning system and configured to transmit at least one high average laser power density signal there through. At least one diffractive optical element may be in optical communication with the first lens group and configured to receive the at least one high average laser power density signal from the first lens group and transmit the at least one high average laser power density signal there through. Lastly, at least a second lens group having one or more refractive optical elements therein may be used in the lens system. The second lens group may be in optical communication with the high average power laser scanning system via the diffractive optical element. The second lens group may be configured to transmit the high average laser power density signal there through. In one embodiment, the first lens group, diffractive optical element, and the second lens group cooperatively form a telecentric lens system configured to output one or more small illumination spots on a flat imaging plane or surface.

Other features and advantages of the lens system for use in high laser power density scanning systems as described herein will become more apparent from a consideration of the following detailed description.

### BRIEF DESCRIPTION OF THE DRAWINGS

The novel aspects of the lens system for use in high laser power density scanning systems as disclosed herein will be more apparent by review of the following figures, wherein:

FIG. 1 shows a side view of an embodiment of the lens system for use with a high laser power density scanning system wherein at least one diffractive element is formed on the first lens group;

FIG. 2 shows a side view of an embodiment of the lens system for use with a high laser power density scanning system wherein at least one diffractive element is formed on the fourth lens group;

FIG. 3 shows a side view of an embodiment of the lens system for use with a high laser power density scanning system wherein at least one diffractive element is formed on the first surface of the first lens group;

FIG. 4 shows a side view of an embodiment of the lens system for use with a high laser power density scanning system wherein at least one diffractive element is formed on the first lens group having multiple high laser power density optical signals propagating there through;

FIG. 5 shows a side view of the location of the multiple high laser power density optical signals projected onto at least one target surface when using the embodiment of the lens system for use with a high laser power density scanning system shown in FIG. 4;

FIG. 6 shows another view of the location of the multiple high laser power density optical signals projected onto at least one target surface when using the embodiment of the lens system for use with a high laser power density scanning system shown in FIG. 4;

FIG. 7 shows graphically the optical performance of the lens system for use with a high laser power density scanning system in terms of encircled energy;

FIG. 8 shows a side view of an embodiment of the lens system for use with a high laser power density scanning system;

FIG. 9 shows a side view of multiple high laser power density optical signals propagating through the embodiment of the lens system for use with a high laser power density scanning system shown in FIG. 8;

FIG. 10 shows of side cross-sectional view of an embodiment of a kinoform lens used in the embodiment of the lens system for use with a high laser power density scanning system shown in FIG. 8; and

FIG. 11 shows a perspective view of an embodiment of the kinoform lens used in the embodiment of the lens system for use with a high laser power density scanning system shown in FIG. 8;

Other features and advantages of the lens system for use with a high laser power density scanning system as described herein will become more apparent from a consideration of the following detailed description.

### DETAILED DESCRIPTION

The present application is directed to a lens system for use in a high laser power density scanning system. More specifically, the lens system may be used in conjunction with a high laser power density scanning system to form one or more features, voids, and/or holes in one or more workpieces or surfaces. For example, in one embodiment the lens system disclosed herein may be used for forming coarse features (features having a traverse dimension of greater than about 900 μm) in a workpiece. In another embodiment the lens system disclosed herein may be used to form features, holes, and the like having a transverse dimension of about 1 μm to about 900 μm in a workpiece. Optionally, the lens system disclosed herein may be used to form features, holes, and the like having a transverse dimension of about 5 μm to about 100 μm on a surface of a workpiece. In another embodiment, the lens system disclosed in the present application may be used to form features, holes, in the like having a transverse dimension of about 10 μm to about 30 μm on a surface of a workpiece.

Unlike prior art systems, the lens system disclosed in the present system may be used with laser-based scanning systems having high average power/high laser fluence. Moreover, the present lens system may be configured to provide a small spot size while maintaining optical performance and having less sensitivity to thermal lensing as compared with prior art systems. Further, the inclusion of at least one kinoform lens or similar diffractive device having at least one diffractive microstructure formed thereon in the lens system provides for color correction over a large spectral range while offering reduced chromatic aberration as compared with prior art systems. In the illustrated embodiments, the kinoform lens or similar diffractive device comprises at least one transmissive diffractive optical device, although those skilled in the art will appreciate that the kinoform lens or similar diffractive device need not be transmissive. In addition, the lens systems described herein may be telecentric configured to output one or more small illumination spots on a flat imaging plane or surface.

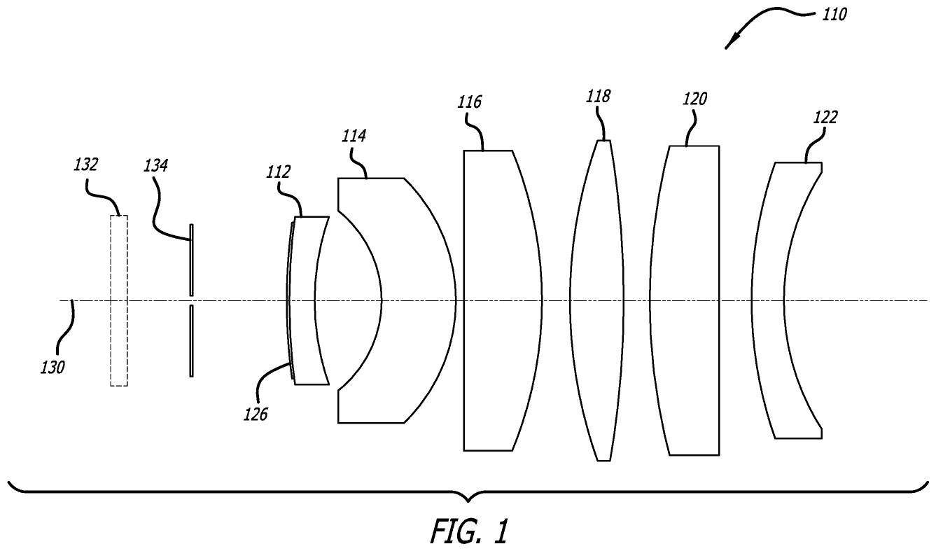

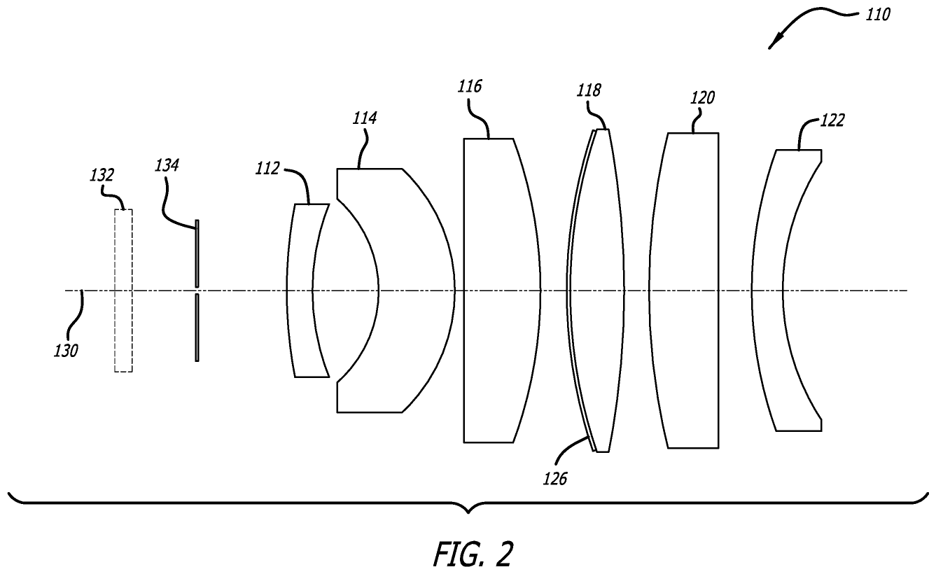

FIGS. 1-3 show various embodiments of the lens system for use with a high laser power density scanning system. As shown, the lens system 110 includes one or more lens groups, each lens group comprised of one or more lenses, mirrors, refractive elements, diffractive elements or features, apertures, stops, filters, and the like. In the illustrated embodiment, the lens system 110 includes a first lens group 112 comprising a single optical element, although those skilled in art will appreciate the any number of optical elements, components, and/or lenses may be used to form the first lens group 112. Similarly, subsequent lens groups may comprise a single lens or multiple optical components. In the embodiment shown in FIG. 1, the first lens group 112 includes a kinoform lens or feature, binary lens or feature, Fresnel lens or feature, and/or a similar device. In contrast, FIG. 2 shows another embodiment the lens system 110 for use within a high laser power density scanning system wherein the fourth lens group 118 comprises a kinoform lens or feature, binary lens or feature, Fresnel lens or feature, and/or a similar device. Optionally, any of the first lens group 112, second lens group 114, third lens group 116, fourth lens group 118, fifth lens group 120, and/or six lens group 122 forming the lens system 110 may comprise a kinoform lens, binary lens, Fresnel lens, and/or a similar device.

Referring again to FIGS. 1-3, any number of diffractive features 126 may be formed on at least one lens groups 112, 114, 116, 118, 120, 122 of the lens system 110. Further, the diffractive features 126 may be formed in any variety of sizes, shapes, distributions, frequencies, and patterns. In one embodiment, the diffractive features 126 may be formed using a ruling engine or a diffraction grating manufacturing process. In another embodiment, the diffractive features 126 may be formed using etching methods and/or direct-write approaches applied to at least one of the lens groups 112, 114, 116, 118, 120, 122 forming the lens system 110. Those skilled in your will appreciate that the diffractive features 126 may be applied using any variety of methods known in the art. Further, the diffractive features 126 may be applied to any lens groups 112, 114, 116, 118, 120, 122 or optical components used to form the lens system 110, and as such, may be positioned anywhere within the lens system 110.

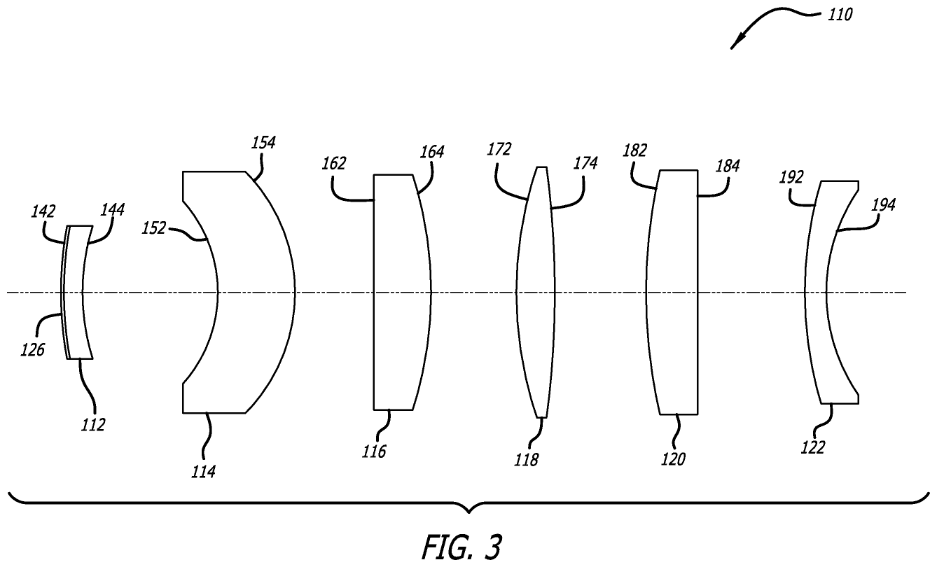

Referring again to FIG. 1-3, the first lens group 112, second lens group 114, third lens group 116, fourth lens group 118, fifth lens group 120, and/or six lens group 122 may be manufactured in any size, shape, or from any variety of materials. For example, as shown in FIG. 3, the first lens group 112 has a first radius of curvature 142 of about 10 mm to about 500 mm or more, and a second radius of curvature 144 from about 3 mm to about to about 300 mm. In another embodiment the first lens group 112 has a first radius of curvature 142 of about 100 mm to about 200 mm, and a second radius of curvature 144 of about 10 mm to about 120 mm. Optionally, the first lens group 112 may have a first radius of curvature 142 of about 135 mm to about 155 mm, and the second radius of curvature 144 of about 50 mm to about 80 mm. In a specific embodiment, the first lens group 112 has a first radius of curvature 142 of about 145 mm to about 150 mm, and a second radius of curvature 144 of about 58 mm to about 62 mm, although those skilled in the art will appreciate that the first lens group 112 may be manufactured having any desired radius of curvatures. Similarly, the first lens group 112 may be manufactured in any desired thickness and/or transverse dimension. One embodiment the first lens group 112 has a thickness of about 1 mm to about 200 mm and a transverse dimension of about 10 mm to about 500 mm. Optionally, the first lens group 112 may have a thickness of about 4 mm to about 10 mm and a transverse dimension of about 25 mm to about 60 mm or more, dependent on the size and configuration of the high laser power density scanning system. In another embodiment, the first lens group 112 has a thickness of about 6 mm to about 6.2 mm and a transverse dimension of about 39.50 mm to about 40.50 mm.

Referring again to FIGS. 1-3, at least a second lens group 114 may be positioned proximate to the first lens group 112. In the illustrated embodiment the second lens group 114 comprises a meniscus lens and/or a convexo-concave lens, although those skilled in the art will appreciate that the second lens group 114 may be manufactured in any variety of lens configurations. Like the first lens group 112 described above, the second lens group 114 may be manufactured in any variety of shapes, sizes, transverse dimensions, from any variety of materials. For example, in one embodiment, the second lens group 114 has a first radius of curvature 152 of about −5 mm to about −200 mm or more, and a second radius of curvature 154 of about −15 mm to about −140 mm. In another embodiment, the second lens group 114 has a first radius of curvature 152 of about −10 mm to about −50 mm, and a second radius of curvature 154 of about −80 mm. Optionally, the second lens group 114 may have a first radius of curvature 152 of about −27 mm to about −32 mm, and a second radius of curvature of about −37 mm to about −43 mm. Further, second lens group 114 may have a transverse dimension of about 5 mm to about 200 mm or more dependent upon the size and configuration of the high laser power density scanning system which incorporates the lens system 110. For example, one specific embodiment, the second lens group 114 has a transverse dimension of about 20 mm to about 60 mm. In another embodiment, the second lens group 114 has a transverse dimension of about 40 mm to about 46 mm.

As shown in FIGS. 1-3, like the first and second lens groups 112, 114 described above, the third lens group 116 includes a first radius of curvature 162 and a second radius of curvature 164. In one embodiment, the third lens group 116 may be manufactured having a first radius of curvature 162 from about 1500 mm to about 5000 mm, and a second radius of curvature of about −50 mm to about −125 mm. Optionally, the third lens group 116 may include a first radius of curvature 162 from about 2500 mm to about 3200 mm, and a second radius of curvature from about −90 mm to about −120 mm. In a more specific embodiment, the third lens group 116 may be manufactured having first radius of curvature from about 2975 mm to about 3000 mm, and a second radius of curvature from about −103 mm to about −109 mm. Further, third lens group 116 may have a transverse dimension of about 20 mm to about 120 mm or more dependent upon the size and configuration of the high laser power density scanning system which incorporates the lens system 110. For example, one specific embodiment of the third lens group 116 has a transverse dimension of about 40 mm to about 80 mm or more. In another embodiment, the third lens group 116 has a transverse dimension of about 60 mm to about 70 mm.

Referring again to FIGS. 1-3, the illustrated embodiments the fourth lens group 118 comprises a bi-convex lens, although those skilled in art will appreciate that any variety of lens configurations may be used. In one embodiment, the fourth lens group 118 includes a first radius of curvature 172 from about 30 mm to about 200 mm, and a second radius of curvature 174 from about −80 mm to about −350 mm. In another embodiment, fourth lens group 118 includes a first radius of curvature 172 from about 80 mm to about 150 mm, and a second radius of curvature 174 from about −200 mm to about −250 mm. Optionally, the fourth lens group 118 may include a first radius of curvature 172 from about 115 mm to about 125 mm, and a second radius of curvature from about −220 mm to about −240 mm. Further, fourth lens group 118 may have a transverse dimension of about 20 mm to about 130 mm or more dependent upon the size and configuration of the high laser power density scanning system which incorporates the lens system 110. For example, in one specific embodiment, the fourth lens group 118 has a transverse dimension of about 50 mm to about 90 mm. In another embodiment, the fourth lens group 118 has a transverse dimension of about 70 mm to about 80 mm.

As shown in FIGS. 1-3, the fifth lens group 120 may comprise a substantially plano-convex lens or similar optical component. For example, in one embodiment the fifth lens group 120 may have a first radius of curvature 182 of about 50 mm to about 400 mm, and a second radius of curvature 184 from about 2000 mm to about 15,000 mm. Another embodiment, the fifth lens group 120 may have a first radius of curvature 182 of about 150 mm to about 220 mm, and a second radius of curvature 184 of about 6000 mm to about 11,000 mm. Optionally, the fifth lens group 120 may have a first radius of curvature 182 of about 175 mm to about 200 mm, and a second radius of curvature 184 of about 9600 mm to about 10,300 mm. Further, the fifth lens group 120 may have a transverse dimension of about 10 mm to about 160 mm or more. Optionally, the fifth lens group 120 may have a transverse dimension from about 40 mm to about 120 mm. More specific embodiment, the fifth lens group 120 may have a transverse dimension from about 70 mm to about 80 mm.

Referring again to FIGS. 1-3, the lens system 110 may include a sixth lens group 122. In the illustrated embodiments, the sixth lens group 122 comprises a meniscus lens, although those skilled in the art will appreciate that any variety of optical lenses or components may be used within the sixth lens group 122. In one embodiment, the sixth lens group 122 has a first radius of curvature 192 of about 15 mm to about 300 mm, and a second radius of curvature 194 of about 5 mm to about 200 mm. In another embodiment, the sixth lens group 122 has a first radius of curvature 192 of about 50 mm to about hundred 50 mm, and a second radius of curvature 194 of about 25 mm to about 75 mm. Optionally, the sixth lens group 122 may have a first radius of curvature 182 of about 95 mm to about 108 mm, and a second radius of curvature 184 of about 45 mm to about 60 mm. Like the preceding lens groups described above, the sixth lens group 122 may be manufactured having any of transverse dimensions dependent upon the size of the system incorporating the lens system 110. For example, in one embodiment, the sixth lens group 122 has a transverse dimension of about 40 mm to about 160 mm, although those skilled in the art will appreciate that the transverse dimension of the sixth lens group 122 may be varied. One specific embodiment, the sixth lens group 122 has a transverse dimension of about 55 mm to about 75 mm.

The lens groups 112, 114, 116, 118, 120, 122 described above may be manufactured from any variety of materials including, for example, fused silica. In another embodiment, the first lens group 112 may be manufactured from borosilicate. Optionally, the first lens group may be manufactured from any variety of materials, including, without limitation, silica materials, quartz, composite glass materials, calcium fluoride, ceramics, diamond, sapphire, and the like. In one embodiment, the lens groups 112, 114, 116, 118, 120, 122 are manufactured from the same material. For example, the lens groups 112, 114, 116, 118, 120, 122 forming the lens system 110 may be manufactured from fused silica. As such, the absorption, distortion, dispersion, thermal characteristics, and other performance characteristics of the material is consistent between the various lens groups 112, 114, 116, 118, 120, 122. In contrast, the lens groups 112, 114, 116, 118, 120, 122 forming the lens system 110 may be manufactured from multiple and/or different materials. Further, at least one of the lens groups 112, 114, 116, 118, 120, 122 may include at least one optical coating thereof. Exemplary optical coatings include, without limitations, anti-reflective coatings, dispersive coatings, wavelength filter coatings, and the like.

Optionally, one or more additional optical components, lenses, or elements may be used in the lens system 110. In the illustrated embodiment at least one additional optical component 132 and at least one stop 134 are positioned along the optical axis 130 the lens system 110. Exemplary additional optical components 132 include, without limitations, beam splitters, filters, lenses, diffractive elements, refractive devices, spatial filters, stops, irises, sensors, polarizers, modulators, mirrors, and the like. Further, the additional optical component 132 and stop 134 may be positioned anywhere within the lens system 110.

The lens system the lens system 110 shown in FIGS. 1-3 may be used with any variety of light sources. For example, in one embodiment the lens system 110 is configured for use with a high laser power density light source configured to emit at least one optical signal having a wavelength from about 200 nm to about 3000 nm. Another embodiment, the lens system 110 is configured for use with a high laser power density light source configured to emit at least one optical wavelength from about 400 nm to about 550 nm. In a specific embodiment, the lens system 110 is configured for use with a high laser power density light source configured to emit at least one optical wavelength from about 510 nm to about 520 nm. Further, the lens system 110 may be used with continuous wave laser system or a pulsed laser system. For example, then system 110 may be used with a laser system configured to output a pulsed laser signal having a wavelength of about 515 nm bandwidth of about 0.2 nm to about 2 nm FWHM, although those skilled in the art will appreciate that the lens system 110 may be used with any variety of laser systems or light sources.

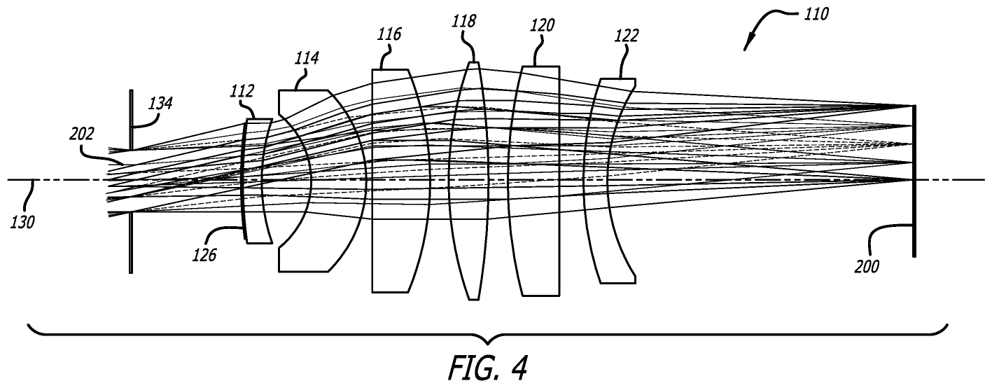

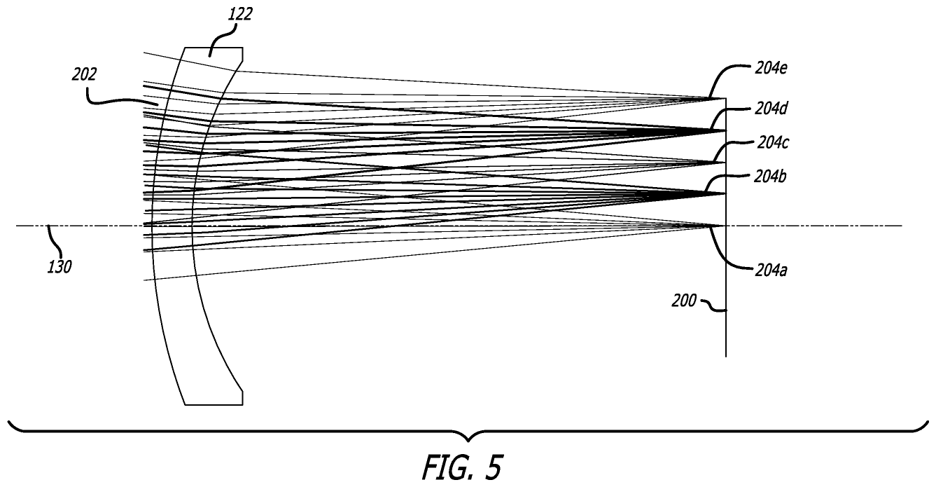

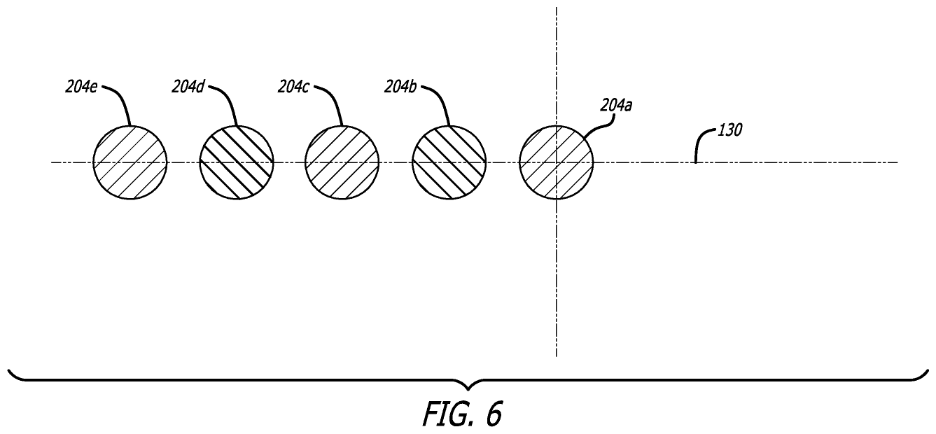

FIGS. 4-6 show various views of the lens system 110 having one or more optical signals traversing there through. As shown, the optical signals 202 may be aligned along the optical axis 130 of the lens system 110 and may be directed through a stop 134 or similar optical element or component included within the lens system 110. Thereafter, the optical signals 202 are incident on the first lens group 112, which in the illustrated embodiment comprises a kinoform lens or device. As shown, the optical signals 202 traverse through the lens system 110 and are incident upon at least one workpiece and/or work surface 200 or similar target. As shown, the lens system 110 may be configured to be telecentric. Optionally, the lens system 110 may be configured to be non-telecentric. Further, as shown in FIGS. 5 and 6, at least one angle of incidence of output signals 204a, 204b, 204c, 204d, 204e projected onto the work surface 200 is substantially orthogonal to the work surfaced 200. The illustrated embodiment the angle of incidence of the output signals 204a-204e are all substantially orthogonal to the work surface 200, although those skilled in the art will appreciate that the angle of incidence of at least one output signal 204a-204e need not be orthogonal to the work surface 200. As shown in FIG. 6 the output signals 204a-204e are substantially and consistently circular have a substantially uniform intensity over a large flat field. Unlike prior art devices, the lens system 110 disclosed the present application substantially reduces lateral chromatic aberration, longitudinal chromatic aberration, as well as other aberrations, thereby improving performance of the laser scanning system incorporating lens system 110.

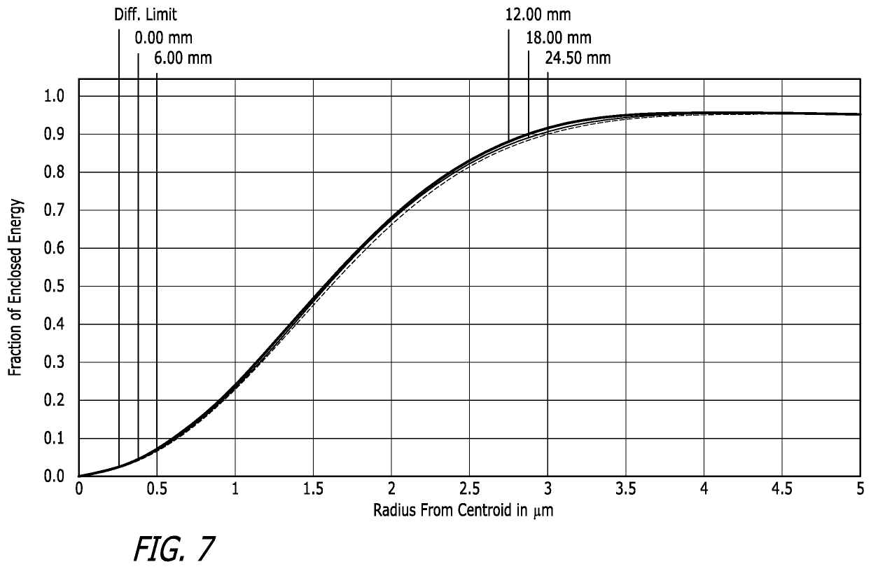

FIG. 7 illustrates the optical performance of the lens system 110 (including design errors and diffraction effects) in terms of encircled energy. More specifically, FIG. 7 shows that within each output signal 204a-204e the polychromatic encircled energy is greater than 90% over the full field-of-view and very close to the ideal diffraction-limited performance, thus ensuring uniformly circular energy distributions at the image plane. In the illustrated example, the transverse dimension of each output signals 204a-204e is about 3.0 mm, although those skilled in the art will appreciate that the transverse dimension of each output signals 204a-204e (or blur radius) may be easily varied.

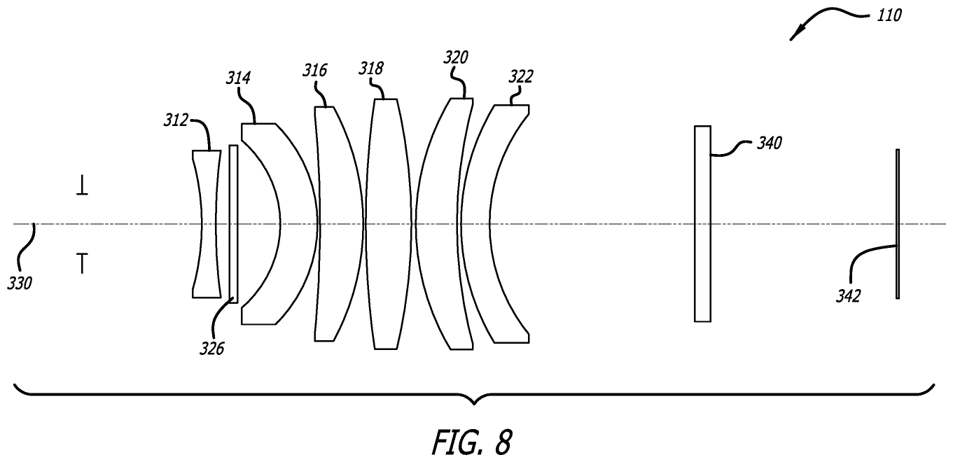

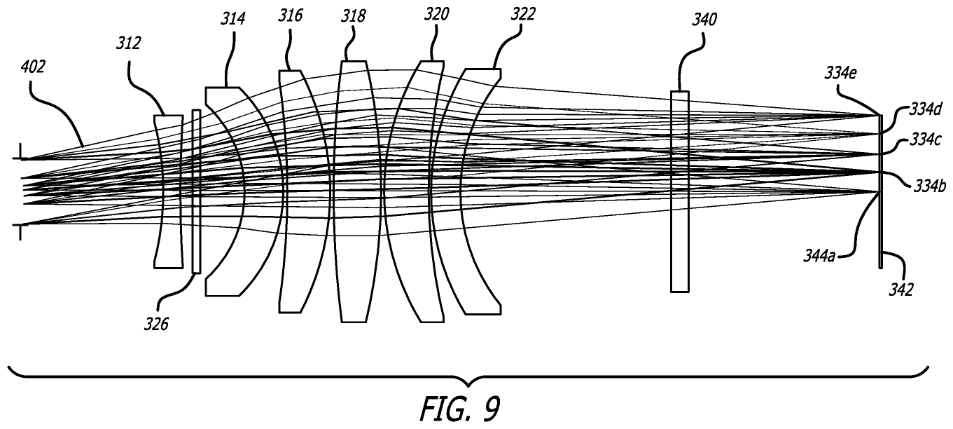

FIG. 8-11 show various view of another embodiment of a lens system for use with a high laser power density scanning system. Like the previous embodiment, the lens system 310 includes one or more lens groups, each lens group comprised of one or more lenses, mirrors, diffractive elements or features, apertures, stops, filters, and the like configured to condition or otherwise modify an incident optical signal 402. Further, in the illustrated embodiments, the lens system 310 comprises a telecentric lens system; although those skilled in the art will appreciate that the lens system 310 need not be telecentric. In the illustrated embodiment, the lens system includes a first lens group 312, second lens group 314, third lens group 316, fourth lens group 318, fifth lens group 320, and/or six lens group 322 or more. However, rather than the embodiments shown above, the lens system 310 shown in FIGS. 8-11 includes at least one kinoform lens or similar diffractive element 326 positioned within the lens system 310 rather than at least one diffractive feature (e.g. a blazed diffractive microstructure) formed on at least one of one of lens groups 312, 314, 316, 318, 320, 322 of the lens system 310. In the illustrated embodiment, the kinoform lens 326 is located between the first lens group 312 and the second lens group 314. Optionally, the kinofrom lens 326 may be located anywhere within the lens system 310. As shown in FIG. 9, like the embodiments shown in FIGS. 4 and 5 and described above, the output signals 334a-334e of the lens system 310 are substantially and consistently circular have a substantially uniform intensity over a large flat field. Unlike prior art devices, the lens system 310 disclosed the present application substantially reduces lateral chromatic aberration, longitudinal chromatic aberration, as well as other aberrations, thereby improving performance of the laser scanning system incorporating lens system 310.

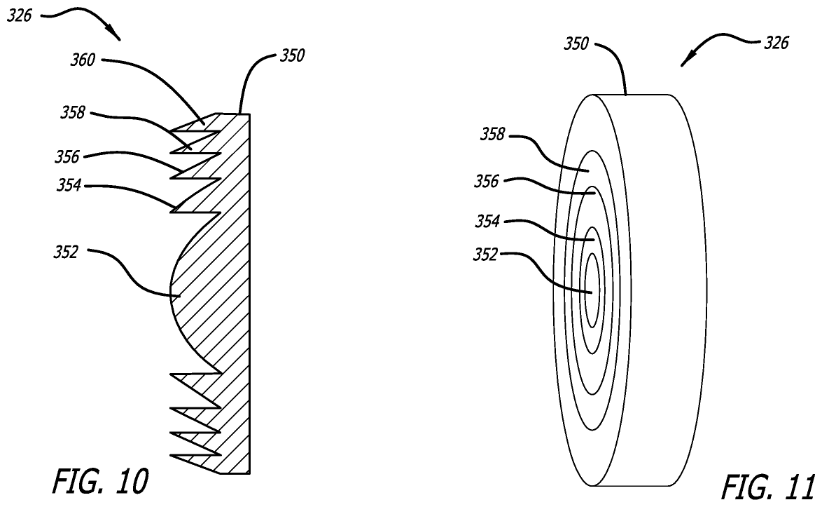

FIGS. 10 and 11 show various views of an embodiment of an exemplary kinoform lens 326 for use in the embodiment of the lens system 310 shown in FIG. 8. As shown, the kinofrom lens 326 may include at least one lens body 350 having a central body or region 352. Further, one or more diffractive features and/or elements may be formed or positioned proximate to the central body or region 352. In the illustrated embodiment, a first diffractive feature 354, a second diffractive feature 356, a third diffractive feature 358, and a fourth diffractive feature 360 are positioned proximate to the central body 352. In one embodiment, the central body 352 and diffractive features 344, 356, 358, 360 may be configured to form at least one diffractive structure 362 of the lens body 350. In the illustrated embodiment, the diffractive structure 362 forms a diffractive microstructure. For example, the diffractive structure 362 may be formed by diffractive ruling or other methods known in the art. Optionally, any number of diffractive features may be formed on or positioned proximate to the central body 352. Further, the kinoform lens 326 and the various elements of the kinoform lens 326 (e.g. lens body 350, central body 352, the various diffractive features) may be formed in any variety of sizes, shapes, frequencies, configuration, and the like. Further, in one embodiment, the kinofrom lens 326 is manufactured from fused silica (SiO₂ or similar material), although those skilled in the art will appreciate that the kinoform lens 326 may be manufactured from any variety of materials. The embodiments disclosed herein are illustrative of the principles of the invention.

Other modifications may be employed which are within the scope of the invention. Accordingly, the devices disclosed in the present application are not limited to that precisely as shown and described herein.

What is claimed:

1. A lens system for use with a high laser power density scanning system, comprising:
a first lens group having one or more refractive optical elements therein, the first lens group in optical communication with at least one high average power laser scanning system, the first lens group configured to transmit at least one high average laser power density signal there through;
at least a second lens group having one or more refractive optical elements therein, the second lens group in optical communication with the at least one high average power laser scanning system via the first lens group, the second lens group configured to transmit the at least one high average laser power density signal there through; and
at least one diffractive optical element in optical communication with at least one of the first lens group and the second lens group, the at least one diffractive optical element configured to transmit the at least one high average laser power density signal there through.

2. The lens system of claim 1 wherein the first lens group comprises a single refractive lens.

3. The lens system of claim 1 further comprising:
a third lens group in optical communication with the second lens group, the third lens group comprising one or more refractive optical elements therein;
a fourth lens group in optical communication with the third lens group, the fourth lens group comprising one or more refractive optical elements therein;
a fifth lens group in optical communication with the fourth lens group, the fifth lens group comprising one or more refractive optical elements therein; and
at least a sixth lens group in optical communication with the fifth lens group, the at least a sixth lens group comprising one or more refractive optical elements therein.

4. The lens system of claim 3 wherein the at least one diffractive optical element is positioned within the lens system between the first lens group and the second lens group.

5. The lens system of claim 3 wherein at least one of the first lens group, second lens group, third lens group, fourth lens group, fifth lens group, sixth lens group, and diffractive optical element is manufactured from fused silica.

6. The lens system of claim 5 wherein the at least one diffractive optical element is formed on at least one of the first lens group, second lens group, third lens group, fourth lens group, fifth lens group, sixth lens group.

7. The lens system of claim 1 wherein the at least one diffractive optical element comprises at least one kinoform lens.

8. The lens system of claim 1 wherein the at least one diffractive optical element comprises at least one lens body having one or more diffractive microstructures formed thereon.

9. The lens system of claim 1 wherein the at least one diffractive optical element comprises at least one lens body having one or more blazed diffractive microstructures formed thereon.

10. A lens system for use with a high laser power density scanning system, comprising:
a first lens group having one or more refractive optical elements therein, the first lens group in optical communication with at least one high average power laser scanning system, the first lens group configured to transmit at least one high average laser power density signal there through;
at least one diffractive optical element in optical communication with the first lens group and configured to receive the at least one high average laser power density signal from the first lens group and transmit the at least one high average laser power density signal there through; and
at least a second lens group having one or more refractive optical elements therein, the second lens group in optical communication with the at least one high average power laser scanning system via the at least one diffractive optical element, the second lens group configured to transmit the at least one high average laser power density signal there through.

11. The lens system of claim 10 further comprising:
a third lens group in optical communication with the second lens group, the third lens group comprising one or more refractive optical elements therein;
a fourth lens group in optical communication with the third lens group, the fourth lens group comprising one or more refractive optical elements therein;
a fifth lens group in optical communication with the fourth lens group, the fifth lens group comprising one or more refractive optical elements therein; and
at least a sixth lens group in optical communication with the fifth lens group, the at least a sixth lens group comprising one or more refractive optical elements therein.

12. The lens system of claim 10 wherein at least one of the first lens group, second lens group, third lens group, fourth lens group, fifth lens group, sixth lens group, and diffractive optical element is manufactured from fused silica.

13. The lens system of claim 5 wherein the at least one diffractive optical element is formed on at least one of the first lens group and second lens group.

14. The lens system of claim 10 wherein the at least one diffractive optical element comprises at least one kinoform lens.

15. The lens system of claim 10 wherein the at least one diffractive optical element comprises at least one lens body having one or more diffractive microstructures formed thereon.

16. The lens system of claim 10 wherein the at least one diffractive optical element comprises at least one lens body having one or more blazed diffractive microstructures formed thereon.

17. A lens system configured to mitigate the effects of chromatic aberration and thermal lensing for use with a high laser power density scanning system having, comprising:
a first lens group having one or more refractive optical elements therein, the first lens group in optical communication with at least one high average power laser scanning system, the first lens group configured to transmit at least one high average laser power density signal there through;
at least one diffractive optical element in optical communication with the first lens group and configured to receive the at least one high average laser power density signal from the first lens group and transmit the at least one high average laser power density signal there through; and
at least a second lens group having one or more refractive optical elements therein, the second lens group in optical communication with the at least one high average power laser scanning system via the at least one diffractive optical element, the second lens group configured to transmit the at least one high average laser power density signal there through, wherein the first lens group, at least one diffractive optical element, and the at least a second lens group cooperatively form a telecentric lens system configured to output one or more small illumination spots on a flat imaging plane or surface.

18. The lens system of claim 17 wherein the at least one diffractive optical element comprises at least one kinoform lens.

19. The lens system of claim 17 wherein the first lens group, at least one diffractive optical element, and at least a lens group are manufactured from fused silica.
